(19) United States
(12) Patent Application Publication
(10) Pub. No.: US 2007/0155411 A1
(43) Pub. Date: Jul. 5, 2007

(54) Interactive mobile messaging system

(76) Inventor: James Morrison, Las Vegas, NV (US)

Correspondence Address: JONES DAY, 222 EAST 41ST ST, NEW YORK, NY, 10017, US

(21) Appl. No.: 11/648,947

(22) Filed: Jan. 3, 2007

Related U.S. Application Data
(60) Provisional application No. 60/756,588, filed on Jan. 4, 2006.

(51) Int. Cl. H04Q 7/20

(52) U.S. Cl. 455/466; 709/206

(57) ABSTRACT

An interactive mobile messaging system (IMMS) for mobile telephone marketing and promotional campaigns integrates interactive voice response (IVR), SMS, fast analysis of shared multidimensional information, and online analytical processing. Online interactive message communication protocols are managed through mobile-originated, short code-based message platforms which are interfaced with an IVR query system. Automatic configuration of multiformat messages can be performed directly into multiple telecommunications carrier networks to all supported mobile handsets.

The present application claims priority to U.S. Provisional Patent Application Ser. No. 60/756,588, filed Jan. 4, 2006, which is hereby incorporated by reference herein in its entirety.

### FIELD OF THE INVENTION

The present invention relates to mobile communications over integrated wide-area networks, and more particularly to interactive messaging systems and methods for delivering messages, applications and other content to mobile users.

### BACKGROUND OF THE INVENTION

In business interactions, information may be communicated to customers or potential customers at various stages in the sales, service and support cycles. In some cases, it may be desirable to deliver messages through one or more electronic channels, such as, for example, E-mail, fax, web pages, or automated voice calls. As mobile telephones and other handheld devices have become more ubiquitous, text messaging, e.g., in the form of short message service (SMS) or premium short message service (PSMS) messages, has become an increasingly desirable communications medium for allowing businesses to interact with customers. For example, in situations where timing is critical and/or where immediate information is desired, SMS messaging can be used as a “hotline”, e.g., for marketing of time-sensitive promotions, or to notify a customer of events such as shipments or electronic transactions.

A shortcoming of current wireless SMS and PSMS marketing systems, however, is that mounting a successful marketing campaign, such as a contest, voting, promotion, coupon program or the like requires that the marketer request and collect the mobile telephone numbers from the consumer so that they can receive their text message or mobile application. This has proven difficult to accomplish through traditional marketing efforts such as signing up through online or paper forms, or trying to collect phone numbers in surveys or traditional information gathering promotions. People are generally reluctant to provide their cell phone numbers through such channels, for fear of receiving unwanted materials or communications, such as SPAM, SPIT or telemarketing calls.

Even using “short codes”, e.g., where a consumer sends a key word to a particular short code number and receives a message back to the telephone, and where the phone number is automatically captured from the consumer's transmission, has seen limited consumer acceptance and use, and therefore little success, in the United States. Most such campaigns require that a consumer wanting to participate in a mobile marketing or messaging campaign know how to text a message to a particular 3, 4, or 5 digit short code in order to participate, and for the marketing or promotional company to capture the incoming number. After that is done the consumer must then receive back an initial confirmation message requesting further permission to allow the marketing or promotion company to send them a message. In many cases the consumer must provide their handset and carrier information in order to receive a message, service or download to their phone.

Another problem faced by companies wanting to reach mobile consumers is that they must follow a strict wireless carrier opt-in/opt-out process, where the consumer must opt-in, or consent, to receive messages from a particular marketer before the marketer may send such messages. Once a user opts-in, the user can opt-out at any time, e.g., by sending a text message back to the marketer. Thus, the SMS marketer must send not only the authorization message to the consumer, but typically must also send opt-out instructions to the consumer along with terms and conditions related to the promotion.

Despite the above-identified drawbacks, there have been some successful two-way SMS campaigns where people text a message or code to a short code system. One example of this is the American Idol voting process, where a customer is charged a fee to send a text message that counts as a vote for a particular contestant. In such cases, when the promotion is presented, e.g., on television or by other media advertisements, to potential voters/customers, all charges are disclosed along with the rules. Because the message is initiated by the consumer and no “offer” is made to the customer, no opt-in/opt-out procedures are required. In such one-time voting processes, no return messages are sent to the consumer's phone number, except perhaps a confirmation that a vote or other message was received. Some such campaigns may be considered successful. However, beyond the revenue generated from standard text messaging charges, they have little marketing value, particularly since the user's number cannot be used for future marketing or promotional campaigns without following the opt-in process or other notice and consent procedures.

Thus there remains a need in the art for an interactive mobile messaging and data distribution system and method for mobile telephone marketing and distribution campaigns.

Discussion or citation of a reference herein will not be construed as an admission that such reference is prior art to the present invention.

### SUMMARY OF INVENTION

The present invention addresses many of the shortcomings and drawbacks found in the prior art. For example, the present invention overcomes the various limitations of prior mobile marketing systems by providing an interactive intelligent messaging and data distribution system for mobile telephone marketing and promotional campaigns.

In one embodiment, an interactive mobile messaging system (IMMS) of the present invention is a complete communications platform that integrates interactive voice response (IVR), SMS, fast analysis of shared multidimensional information, and online analytical processing. Interactive voice response is a telephony technology in which a caller uses touch-tone or voice commands to interact during a telephone call with a database to acquire information from the database or to enter data into the database. Online interactive message communication protocols are managed through mobile-originated, short code-based message platforms which are interfaced with an IVR query system. Automatic configuration of multiformat messages can be performed directly into multiple telecommunications carrier networks to all supported mobile handsets.

In another embodiment, an interactive mobile messaging system comprises an IVR system, a message content generator, a messaging system, an IMMS control center, and one or more data modules. The IVR system, content generator, messaging system, control center and data modules may be stored in one or more memories on one or more computers. The system also preferably includes communications circuitry for communicating with one or more devices over a wide area network, and a central processing unit for controlling overall operation of the system in accordance with the instructions stored in memory. The wide area network may be the Internet, one or more wired or wireless telecommunications networks, or any other communications network.

A method of using an interactive mobile messaging system for a marketing campaign comprises (a) prompting a consumer, or user, to call a particular telephone number to participate in a specific mobile promotion, contest, campaign, or the like; (b) interacting with the user through an interactive voice response system; (c) generating a predetermined or unique message based upon the interaction with the user; and (d) sending the predetermined or unique message to the user. In preferred embodiments, the message may comprise an SMS, PSMS and/or other type or format of message (e.g., E-mail, multimedia messaging system messages, HTML, XML, JAVA, etc.) conveying information to the user's mobile telephone, for example, regarding an offer, prize, coupon or other reward for use by the user.

In some embodiments, the SMS or other message from the system to the user device is triggered by the user's telephone call to an IVR or similar interactive telephone system (or SMS/PSMS origination message), where the caller or consumer may select from one or more IVR menu prompts for a particular service, product, information, promotion, coupon and/or prize. The message may be dynamically generated specifically for the caller based upon specified information such as, for example, a user ID number or other identifier, user preferences, business rules related to the message campaign, or any combination thereof. In some embodiments, user-specific information is stored in the system or in another computer system in communication with the system, and such user-specific information may be used to generate and/or send customized or individualized messages targeted for the particular user.

In other embodiments, a user can input user-specific information that may be used to generate a customized message and/or associated rewards or other content. The reward message sent to a user may comprise a text message, an application, a bar code, a confirmation code, a ticket, or other application, link, device, or any other fulfillment mechanism that may be associated with the reward. The message fulfillment mechanism may be sent, for example, via SMS, PSMS, or multimedia messaging service (MMS), via a browser, e.g., utilizing a wireless application protocol (WAP) or through a JAVA virtual private network (VPN) browser client. When a customer redeems a coupon, reward, ticket, or the like at a redemption center, information regarding the transaction may be captured, either manually or automatically, and sent to the marketer or another database related to the marketer, the user or the campaign.

Another aspect of the present invention provides a computer system for generating a customized web application on a client device. The computer system comprises a client device comprising a central processing unit, a user interface and a memory coupled to the central processing unit. The memory stores a logic engine. The computer system further comprises a server in communication with the client device. The server comprises a server central processing unit and a server memory. The server memory is coupled to the server central processing unit and stores one or more instructions for (i) identifying a caller based upon a unique identifier, (ii) presenting an interactive voice response menu of options to the caller, (iii) generating a message in response to an option selected by the caller from the menu of options and in accordance with information related to the unique identifier; and (iv) sending the generated message to the user. In some embodiments, the message is a text message. In some embodiments, the message comprises a promotion. In some embodiments, the message comprises a software application. In some embodiments, the unique identifier is the MIN of a mobile device. In some embodiments, the unique identifier relates to a rewards account of the user. In some embodiments, the server further comprises instructions for tracking redemption of the promotion.

### BRIEF DESCRIPTION OF THE DRAWINGS

The invention and further developments of the invention are explained in even greater detail in the following exemplary drawings. The present invention can be better understood by reference to the following drawings, wherein like references numerals represent like elements. The drawings are merely exemplary to illustrate certain features that may be used singularly or in combination with other features and the present invention should not be limited to the embodiments shown.

FIG. 1 is a schematic diagram of an interactive intelligent messaging system according to the present invention.

FIG. 2 is a flow chart illustrating a method of delivering customized messages to a user according to an embodiment of the present invention.

FIG. 3 is a flow chart illustrating another method of delivering customized messages to a user according to an embodiment of the present invention.

FIG. 4 is a schematic diagram illustrating exemplary data module components according to an embodiment of the present invention.

FIG. 5 is a schematic diagram of an interactive intelligent messaging system for promotional campaigns.

FIG. 6 is a schematic illustration of a promotional message received by a user according to an embodiment of the present invention.

FIG. 7 is a schematic illustration of another promotional message received by a user according to an embodiment of the present invention.

FIG. 8 is a schematic diagram of a mobile publishing architecture according to one embodiment of the present invention.

Like reference numerals refer to corresponding parts throughout the several views of the drawings.

### DETAILED DESCRIPTION

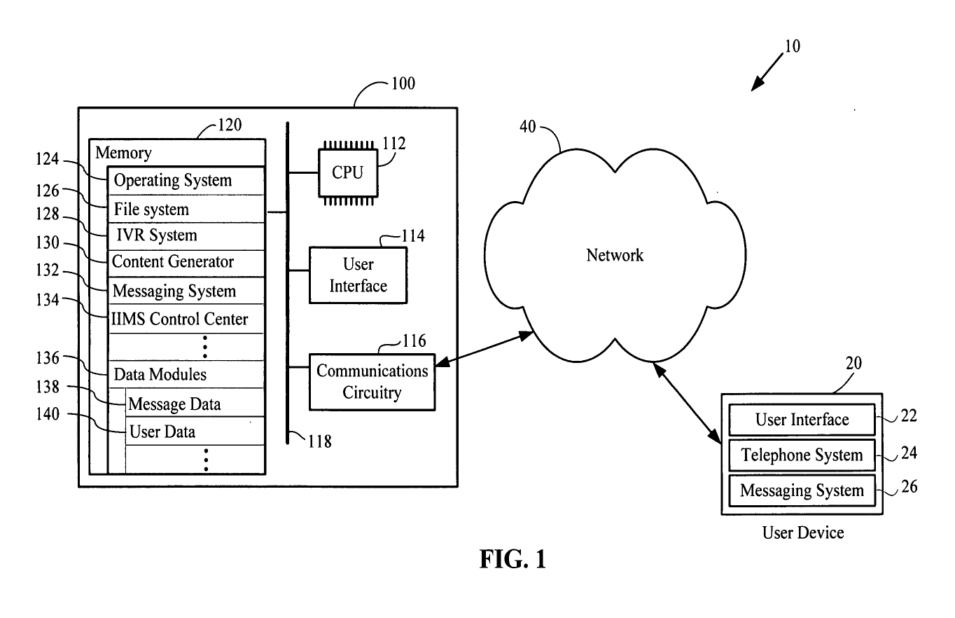

FIG. 1 details an exemplary system 10 that supports the functionality described above and detailed in sections below. System 10 comprises a user device 20 in communication over one or more networks 40 with an interactive messaging system 100. User device 20 can comprise one or more communications devices, and preferably includes a user interface 22 for input and output of information and/or instructions, a telephone system 24 for voice communications over a wired or wireless telephone network, and a messaging system 26 for sending and/or receiving messages, e.g., text messages (such as, for example, SMS, PSMS and/or MMS messages), E-mail messages, etc.

Network 40 can comprise one or more wired or wireless networks, e.g., the Internet or other wide area network (WAN), one or more local area networks, wired or wireless telephone networks (e.g., a telephone network, a voice over integrated packet (VOIP) network, or a GSM, PCS, mobitex, CDMA, IDEN, or other network for voice and/or data communications).

In a preferred embodiment, interactive messaging system 100 may comprise a central processing unit 112, a user interface 114, communications circuitry 116, a memory 120 and a bus 118 to connect the aforementioned components. Memory 120 may comprise volatile and non-volatile storage units, for example hard disk drives, random-access memory (RAM), read-only memory (ROM), flash memory and the like. In preferred embodiments, memory 120 comprises high-speed RAM for storing system control programs, data, and application programs, e.g., programs and data loaded from non-volatile storage. User interface 114 may comprise one or more input devices, e.g., keyboard, key pad, mouse, scroll wheel, and the like, and a display or other output device. A network interface card or other communication circuitry 116 provides for connection to any wired or wireless communications network 40, which may include the Internet and/or any other wide area network, and in particular embodiments comprises a telephone network such as a mobile telephone network.

Operation of messaging system 100 is controlled primarily by operating system 124, which is executed by central processing unit 112. Operating system 124 can be stored in system memory 120. In addition to operating system 124, a typical implementation of system memory 120 may comprise any combination of:
a file system 126 for controlling access to the various files and data structures used by the present invention;
an IVR system 128 for interacting with a user calling via telephone system 24, the IVR system configured to present the user with a menu of options and respond to the selections or commands made by the user;
a content generator 130 for generating content for messages to be sent to the caller, for example in response to selections made by the user and/or user-specific information stored in or retrieved by the system;
a messaging system 132 for sending and receiving messages, including text messages (e.g., SMS, PSMS, MMS, and the like), E-mail messages, and/or other types of electronic messages;
an IMMS control center 134 for controlling communications with a user, including, for example, real-time updating of message contents and parameters to message and control configurations such a as IVR systems prompts, responses and audio messages; and
data modules 136 including databases and other data structures comprising, e.g., message data, user data, and other information that may be used in during operation of the system and/or for generating and recording messages.

In some embodiments, a dual tone multi-frequency hybrid system is used instead of or in addition to IVR system 128. In some embodiments, each of the aforementioned data structures that are stored or accessible to messaging system 100 is a single data structure. In other embodiments, any or all such data structures may comprise a plurality of data structures (e.g., databases, files, archives) that may or may not all be stored on messaging system 100. For example, in some embodiments, data modules 136 comprise a plurality of structured and/or unstructured data records that are stored on messaging system 100 and/or on computers that are addressable by messing system 100 across the network 40.

User device 20 may also be a processor-based computer system, comprising a CPU for controlling overall operation of the device, communications circuitry for communicating over one or more networks and/or a memory storing an operating system and various other application modules, data modules, data structures, and the like. In particular embodiments, user device 20 is a mobile telephone comprising a user interface 22, a telephone system 24 and a messaging system 26. User interface 22 may comprise a display for displaying text messages, graphics, and or other information to the user, and a user input device such as a keypad, soft keys, buttons, a scroll wheel, or any other device for inputting user instructions and commands. Telephone system 24 comprises a speaker, a receiver, and other circuitry and/or software commonly known and used in the art for telephone communications. Messaging system 26 may comprise text messaging software, an E-mail application, pager software, or any other hardware or software modules for conveying text or graphical messages to a user. Various other aspects, details and functions of device 20 are described below.

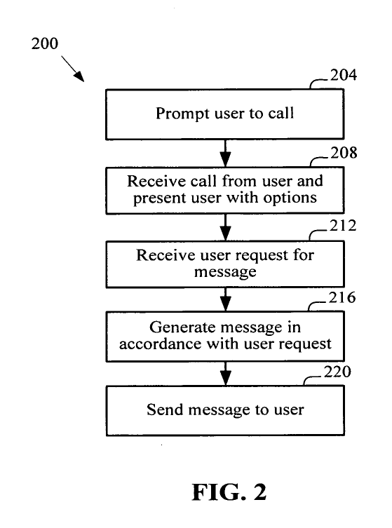

Referring now to FIG. 2, in an exemplary method 200 of providing messages to a user, a user is first prompted 204 to call a particular telephone number associated with messaging system 100. The user may be prompted to call the telephone number, for example, by an advertisement appearing on television, radio, a website, E-mail message, text message, mail, or any other communications or advertising medium. In some embodiments, the user is prompted to make the call by an E-mail or a text message to which the user can reply, or which contains a link or icon that can be selected by the user to initiate the call.

When a user responds to the prompt and calls the designated number, the call is received at step 208. After the call from the user is received, messaging system 100 presents the user with a menu of options, e.g., using IVR system 128. For example, at least one of the options comprises one or more selections for the user to request to receive a message from messaging system 100. In some embodiments, a number of options may be presented, for example in a tree of IVR options that provide for customized requests and/or selections by the user. The user may also be prompted to enter additional information, such as a personal identification number, an account number, a name, or other data or information that may be used by the system to select or customize a desired text message, promotion, reward, application or other message to the user.

In step 212, messaging system 100 receives from user device 20 a selection or request, which may comprise, for example, a voice command, one or more touch-tones, or other commands that correspond to a particular selection or request from the user, e.g., a request to receive a message from messaging system 100. In step 216 of exemplary method 200, messaging system 100 generates a message in accordance with the request received from the user in step 212. In some embodiments, other information received from the user, the user's device 20 and/or from external sources or databases (including, for example, third-party databases) may also be used in generating and/or customizing the message; e.g., a user identifier, user profile information, user preferences, the user's calling area and/or area of residence, a member ID number, an account number or other account information, previous usage information or parameters, historical data associated with the user or a user group. In step 220, the message is sent to the user.

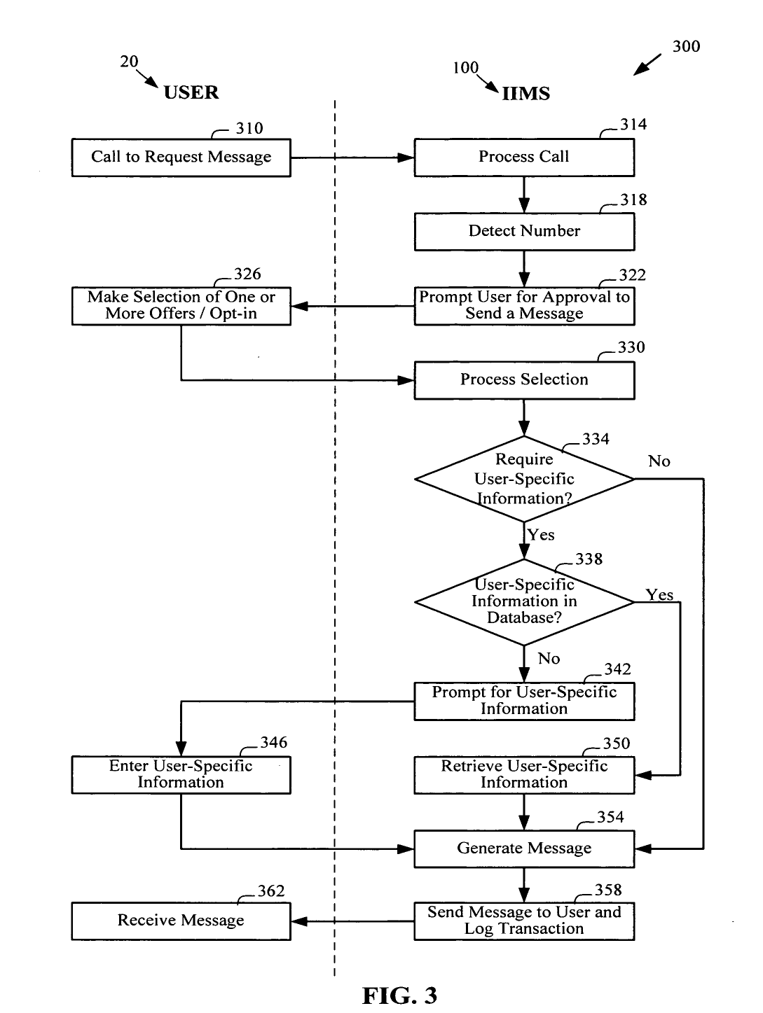

FIG. 3 is a flowchart providing additional details of a method 300 for interactive mobile messaging between a user device and messaging system 100 of FIG. 1, according to an embodiment of the present invention. In step 310, a user contacts messaging system 100 to request that a message be sent to the user. As with method 200, the user's call may be made in response to an advertisement, promotion, a website, an E-mail message, a text message, post mail message, or any other communication means that prompts the user to contact messaging system 100, for example in order to receive a promotion, award, gift, credit, or the like. In the example 300 shown in FIG. 3, the call to request a message 310 preferably comprises a telephone call from user device 20 to a dedicated telephone number that may be specific to a particular promotion or advertising campaign. User device 20 may be, for example, a cellular telephone or other mobile device capable of making telephone calls over a wired or wireless network and receiving electronic messaged such as, for example, text messages or E-mail messages. In other embodiments, the call by the user comprises an electronic message, e.g., a text message, E-mail, or a web link selection.

In step 314, messaging system 100 processes the call from user device 20. In one embodiment, IVR system 128 comprises a call center for answering telephone calls to be processed by the IVR system. In other embodiments, a call center may or may not be part of IVR system, and may receive and/or route calls to IVR system 128 or to a dual tone multi-frequency DTMF system or other interaction module or system for processing telephone calls that is in electronic communication with messaging system 100. In some embodiments a commercially available IVR system may be customized for use as IVR system 128. Examples of commercially available IVR systems include those provided by Voxeo (Orlando, Fla.) and IVR Software Development (Vancouver, British Columbia).

In step 318, the telephone number of the user device 20 is preferably automatically determined without any requirement that the user provide the number. If the telephone number can be determined automatically, e.g., it is not blocked, the caller telephone number, or a corresponding identifier, is processed to determine if the number is a mobile telephone number or not. If the number is a mobile telephone number, the caller mobile phone number carrier is determined in a look-up process. The system places the number into an information processing database, which may include other information, including identifiers, classification information, or other information or parameters that may be user-specific and/or promotion specific.

If the detected number is not a mobile number, messaging system 100 may store the non-mobile number, and prompt the user to enter a mobile number to which a return message (e.g., a text message comprising a promotion, coupon, reward, etc.) should be sent. Optionally, messaging system 100 may retrieve additional information related to the caller's telephone number from data modules 136 or other data sources which may be external to messaging system 100.

In some embodiments, the number that is detected in step 318 is the mobile identification number (MIN) number of device 20. The MIN number is a unique 24-bit number that is assigned by the wireless service provider (carrier) to each phone included in the services plans of the carrier. Unlike the electronic serial number (ESN) provided with each mobile phone, a MIN is changeable because device 20 may change hands or device 20 owners may move to another coverage region, requiring a different, requiring a different service plan. The MIN and ESN are automatically transmitted to the wireless network each time the device 20 is used.

After automatically determining or otherwise receiving the caller's telephone number, messaging system 100 in step 322 prompts the user to approve the sending of a message, e.g. an SMS message or E-mail message. For example, IVR system 128 of messaging system 100 can present the user with an opt-in prompt to authorize the sending of the message to the user's device 20, e.g., using the detected mobile telephone number. In preferred embodiments, messaging system 100 notifies the user, e.g., through IVR system 128 or recorded message, of any charges, if any, to the caller for using messaging system 100 or for participating in the promotion or campaign. Optionally, IVR system 128 or other module or system of messaging system 100 presents other prompts or a menu of items that may be selected by the user. For example, a menu of one or more offers may be presented to the caller, and the caller is requested to select one or more of the presented offers, e.g., by a voice command, key entry, or other input or command, e.g., using user interface 22 of device 20 in step 326.

Before, after, or in conjunction with the prompt 322/selection 326 process, messaging system 100 may also collect other identification information, such as, for example, mobile station identifier (MSID), E-mail address, browser configuration, handset model, mobile equipment identifier (MEID), electronic serial number (ESN), device operating system (OS), etc. Messaging system 100 may also collect user location information, for example so that it can provide appropriate location sensitive offers, promotions or prizes to the caller. Such user location information may be collected, for example, by using the caller's area code, the location of the mobile station corresponding to the MSID or location based services (LBS) data, or by having the user enter or speak location information in response to a prompt. Location based services are offered by some cell phone networks as a way to send custom advertising or other information to device 20 subscribers based on their current location. The service provider gets the location from an optional global positioning system (GPS) chip built into user device 20, or using radiolocation and trilateration based on signal-strength of the closest cell-phone towers (for user devices without GPS capability). In some countries, such as England, networks do not use trilateration; LBS uses a single base station, with a “radius” of inaccuracy, to determine a user device's location.

Messaging system 100 may also include an age verification system (AVS), which may, for example, create age based identifiers for specific numbers so that parents can restrict calls to campaigns that may not be appropriate for children of certain ages. Any of the forgoing information may be used to customize the predetermined messages sent to user device 20 and/or be used to make a determination as whether such messages will be sent do user device 20.

After the user enters one or more selections and “opts-in” to receiving particular messages, prizes, rewards, etc. in step 326, messaging system 100 processes the selections in step 330. Depending upon the type of message or campaign, messaging system 100 may require additional user-specific information in step 334. If no additional user-specific information is required (334—No), messaging system 100 generates the requested message in step 354, e.g., using content generator 130 (FIG. 1). For example, in embodiments where it is desirable to broadcast a single directed message back to many callers or consumers, messaging system 100 can look up the appropriate message file (e.g., from message data module 138), and then generate a corresponding message 354 and send the message to the user 358. The user receives the message in step 362. Optionally, messaging system 100 can monitor delivery of the SMS message to the appropriate mobile carrier messaging gateway, then monitor the sending and receipt of such a message.

By way of example, which is not intended to be limiting of the invention, such a promotion in step 322 could read: “To receive your free admission to the amusement park, press ‘1’. To receive your discount food coupon, press ‘2’.” After a user makes a selection in step 326, the IVR system 128 might repeat the selection, and say something like, “To authorize this message to be sent to your phone—standard text message rates apply—press ‘*’.”

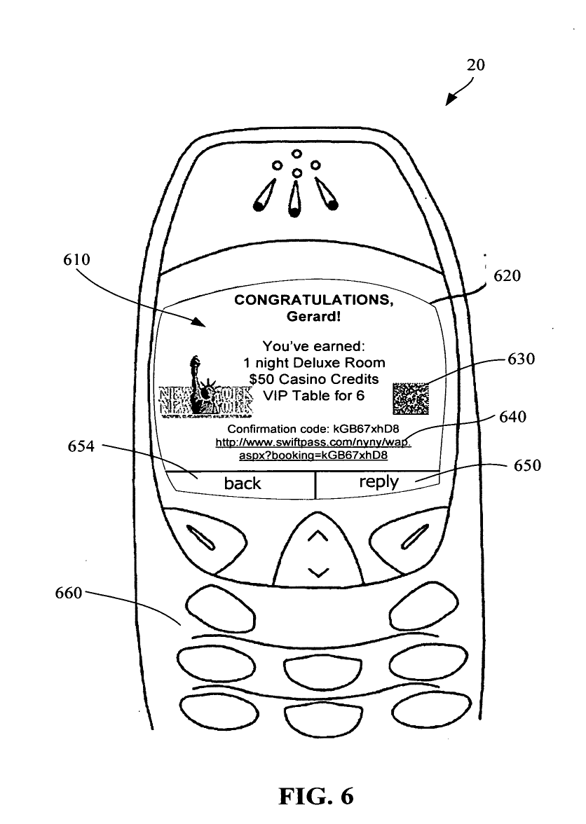

In some embodiments, messaging system 100 looks up the appropriate message file and dynamically generates a unique identifier for each message sent, e.g., a serial number, a code number, a bar code (e.g., such as bar code 630 in FIG. 6), or other identifier for uniquely identifying each message. Such code or other unique identifier may be used, for example, to identify and/or validate the authenticity of the message and the corresponding promotion or coupon when it is redeemed. In such situations, the code and/or identifier may be provided to, provided by and/or shared with the originator of the campaign or promotion, for example by sending information related to the unique identifier to the campaign originator and/or storing such information in a database accessible by the campaign originator. Such unique identifiers or codes for messages of step 354 may also be used to track redemption of a promotion or prize, for example, as a redemption location, and such redemption information may be logged and associated with an account of the user, the provider, etc.

In other embodiments, the message of step 354 may be customized based upon information gathered during the detection step 318 and/or during the user prompt 322/selection 326 process as described above. The message is then sent in step 358 (e.g., using messaging system 132), preferably as an SMS message or similar, back to user device 20. In other embodiments, other types of messages may be sent instead of or in addition to SMS messages, e.g., such as E-mails, voice mails or other messages sent to user devices or systems appropriate for receiving such messages.

Returning now to step 334 of method 300, after messaging system 100 processes the user's selection and/or request to receiving a message in step 330, messaging system 100 may require additional user specific information in order to generate an appropriate message in a particular promotional campaign (334—Yes). For example, the user-specific information might include user or user device identification information described above and which was not obtained or could not automatically be obtained during detection of the number in step 318 or during the prompt and selection process, 322, 326, e.g., user location information, user age information, account information, and the like.

In preferred embodiments, the user-specific information might include an account number or other code identifying the user as a member of a customer loyalty club or other program, for example a club or program where a user earns points or credits that may be redeemed for prizes, coupons, awards, etc. Examples of such customer loyalty clubs or programs include, but are not limited to, frequent flyer programs, frequent shopper clubs or programs (e.g., for retail or wholesale grocery stores, retail stores, wholesale warehouse stores, etc.), casino club programs, hotel loyalty clubs or programs, credit card points programs, and the like.

In step 338, messaging system 100 may check to see if any or all of the required user-specific information is already stored in a database 140 of messaging system 100 or a database in communication with messaging system 100. For example, user customer loyalty account information may have been retrieved by system from an earlier call by user, and such information may have been stored in database 140 and associated with the user's telephone number. Thus, when system detects the telephone number of the user device 20 in step 318, any associated user-specific information, device specific or other account or transaction information may be retrieved in step 350 and used in step 254 to generate the new message or transaction. In preferred embodiments, messaging system 100 has the ability to automatically recognize the identity of a caller in step 318, retrieve corresponding account and/or profile information (338—Yes), and respond with the appropriate offer, message or promotion (354) without the need to collect further identification information from the caller.

If user specific information is required in step 334, but not available in a database in step 338 (338—No), then the user might be prompted in step 342, e.g., by IVR system 128, to enter a customer loyalty number or other identification number or user-specific information that is required. The user may enter the desired information in step 346, and messaging system 100 may store the entered information in memory 120, e.g., in user database 140. Messaging system 100 may then use the entered information, which may or may not be correlated with other user-specific information that was entered by user, previously stored in system or retrieved from an external source, to generate a message in step 354.

When a caller is not a member of a particular loyalty club or other program associated with a campaign or promotion, a temporary identification number can be automatically generated and sent to the phone to allow a caller or customer to participate in the campaign. The system would generate a message back to the phone instructing the caller/consumer on how to fully register their information to become a full member. In some embodiments, messaging system 100 issues prizes and holds them in suspense until the caller calls back. When the caller calls back and messaging system 100 recognizes the mobile number, messaging system 100 reissues the prize to the caller and, optionally, updates the campaign distributor's issuing system.

In one embodiment, the user can call into the messaging system 100, and IVR system 128 can ask them to orally, or by text, enter personal information that is captured by IVR System 128. IVR System 128 then associates the mobile number with the input strings or text, prompts, audio inputs, etc., that constitutes the personal information and generates an identification list with prompts that will populate a database with the caller/consumer information, e.g., within user data module 140. In instances where the user provides oral inputs, such inputs may be converted into text files, for example, through a speech recognition application or manually by listening to the file and transcribing the text. An example of this would be when a caller is asked for their name and the user speaks their name into device 20. The user may then be asked to provide information such as how many are in their party by voice or text, and then a dynamically generated message may be sent back to device 20, e.g., via text message.

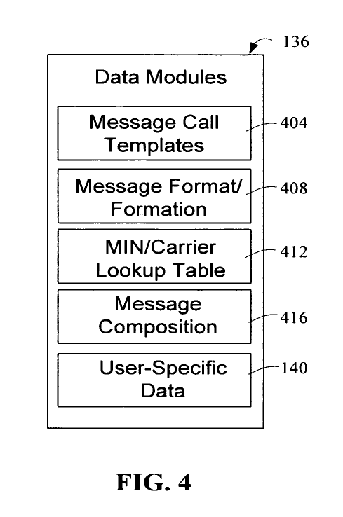

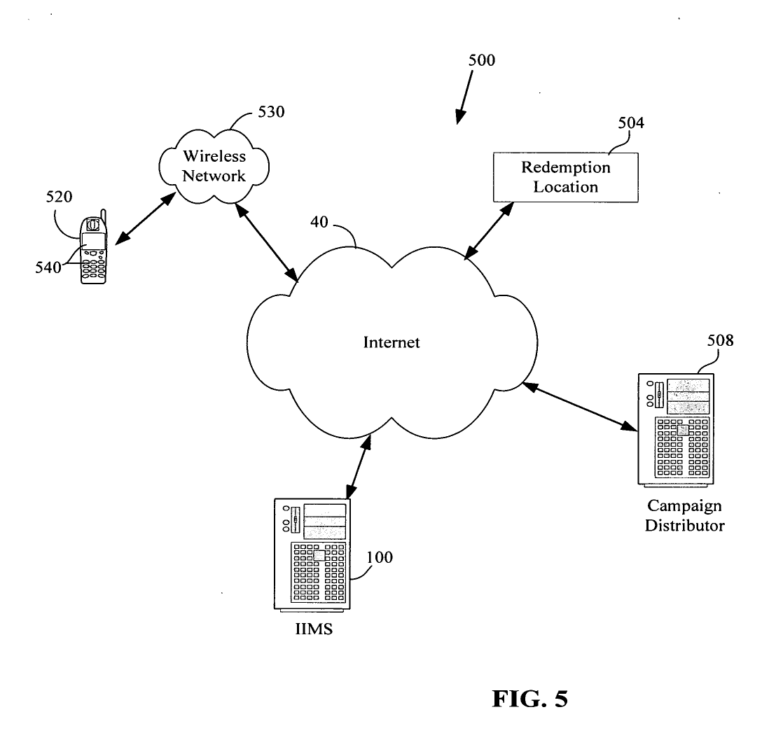

The message of step 354 may be a dynamically generated in accordance with data from data modules 136 as shown in FIG. 4, for example, such as message call templates 404 or message format or formation parameters or rules 408, message composition data 416, or user specific data 140, and/or other data such as device or carrier-specific data 412. The message format, composition, and/or other business rules for generating the message may be provided, for example, by the distributor or broadcaster of the campaign or promotion (e.g., campaign distributor 508 of FIG. 5). The generated message may include and/or identify an associated reward, offer, prize, coupon or the like. The message is sent to the specified user, and the transaction is logged and/or tracked in step 358. For example, the message may be tracked through the carrier gateway. Thus, in step 362, each user receives, in response to their original selection and request in step 326, a specific message based upon their selection, device-specific information, user-specific information, and/or the business rules of the message criteria of the campaign originator or client.

In some embodiments, a system may comprise other modules and process components. For example, in some embodiments, a system information communications module may communicate with internal and external components of messaging system 100 to generate message information that may trigger a general, specific, custom or alert. In some embodiments, a file transfer protocol may be used to generate reports and submit them for processing on a scheduled basis. In some embodiments, a real time XML file transfer process may integrate with a live feed of data to exchange information instantaneously.

In some embodiments, messaging system 100 is built or configured specifically for each campaign and set of business rules. The system is set up to analyze information and dynamically generate and distribute messages and data to the individual handset in accordance with the campaign and corresponding business rules. A processing network includes the ability to interface to real-time systems that generate specific information that is uniquely formatted into messages or data fields, e.g. WAP pages, for viewing by the caller or user. In some embodiments, messaging system 100 creates and distributes messages best suited for the application or handset/network configuration. For example, in one campaign, there may be a combination of SMS, EMS and MMS messages being sent out in step 358, depending upon the handset and/or network capabilities of each user device. Thus, the message in step 358 may be a simple SMS message, an EMS message, an MMS message and/or any combination thereof. The message may also be an SMS WAP push, and/or it may conform to other messaging standards such as the Nokia Smart Messaging System, and other proprietary and non-proprietary systems.

In preferred embodiments, a message control center may allow for the real-time update of all message content and parameters to all message and control configurations, such as the IVR system prompts, responses, and audio messages.

Referring to FIG. 5, an exemplary system 500 is similar to system 10, and can include messaging system 100 as described above with respect to FIG. 1. In this example, user device 20 is a mobile device 520 having cellular telephone and text messaging capabilities (e.g., via SMS, PSMS, MMS, E-mail, or other suitable messaging protocols or systems), and communicates via a wireless network 530. In some embodiments user device 520 comprises one or more wired or wireless communications devices, for example a telephone, a cellular telephone, a personal data assistant, a handheld computer, a laptop computer, a desktop computer, or any other device capable of communicating over a network. User device 520 includes a user interface 540, which may include a telephone handset and/or headset, a display screen, user input keys, a scroll wheel, and/or other input devices.

Wireless network 530 can comprise any wireless network for voice and/or data communications, e.g., a GSM, PCS, mobitex, CDMA, IDEN or other network. Network 40 can be any wide area communications network, e.g., the Internet. Although the exemplary system 500 illustrated in FIG. 5 shows user device 520 communicating with messaging system 100 through wireless network 530 and network 40, one skilled in the art will appreciate that messaging system 100 can receive communications from user device 520 that do not pass through network 40, e.g., telephone calls routed through wired or wireless telephone carrier networks.

In particular embodiments, a campaign or promotion system 500 includes one or more campaign distributor systems 508 and one or more redemption locations 504. Systems 508 and locations 504 preferably can communicate with messaging system 100 over one or more networks 40. For the redemption and validation of the tickets, a range of devices may serve as redemption locations 504. These include, for example, a Kiosk unit, OEM scanning components for inclusion into access control or other infrastructure and a small desktop unit. In another embodiment, a wireless handheld scanning device may be used to scan a mobile ticket.

In this example, user device 520 is shown as a mobile telephone as described above, and communicates with messaging system 100 over a wireless network 530 and/or other telecommunications network and network 40. In such embodiments, any user information and/or transaction information stored in messaging system 100, e.g. information related to transactions or promotions that have been sent, can form the basis of a report that is communicated back to campaign distributor 508. Campaign distributor 508 may use such reports to track the progress of a campaign or promotion, to update their records regarding specific users and/or redemption of rewards.

The process for delivering and tracking redemption of such tickets may include one or more levels of security features and inhibitors for minimizing fraud and abuse. Further, by using the mobile telephone as a verification tool means that the mobile ticket's unique entities can't be duplicated or used anywhere else. The process is preferably flexible, scalable and accessible. The flexibility may be enabled by one or more algorithms that deliver the tickets with precision. Messaging system 100 can connect with many carrier technologies, such as, for example, CDMA and GSM. Such contestability allows system 500 to manage enormous volumes of tickets. Overall, system 500 provides an immensely powerful enterprise solution for numerous organizations across a wide range of high traffic sectors. System 500 has been built to be platform independent and can accommodate information being pushed into messaging system 520 as well as passing information out. Furthermore, the application can be integrated seamlessly into many systems including: point of sale (POS), customer relationship management (CRM), and access control. System 500 and related applications for mobile ticketing are preferably fully controllable and customizable, and may be managed through a secure, web-based application.

FIG. 6 shows an example of a message 610 on user interface screen 620 of a user device 20. The promotional message 610 may have been generated by messaging system 100 and delivered to user device 20 in response to a call from the user, for example, as described above with respect to FIGS. 2 and 3. The user device in this example is preferably a mobile telephone, and includes input keys 660, and soft keys 654, 650 for interacting with the message.

In this example, the message is a reward for a free hotel room and casino credits. The message may include one or more redemption devices, e.g., a confirmation code, a password, a web link 640, or another link (e.g. to a telephone number) or device. In preferred embodiments, the message includes a bar code, e.g., a two-dimensional bar code 630 that may be scanned directly from the telephone at a redemption site (e.g., at the hotel). Softkeys 654 and 650 may allow the user to reply to the message, e.g., by return call or text message, or to navigate to a previous “page” or to another feature, page of information, or “location” as desired.

In other embodiments, the message can be configured to send SMS, EMS, MMS, WAP, JAVA or other mobile applications directly to device 20. While promotion fulfillment, e.g., delivery of the message, in this case is made to device 20, other alerts might also be sent to other devices or services like E-mail or even voice messages.

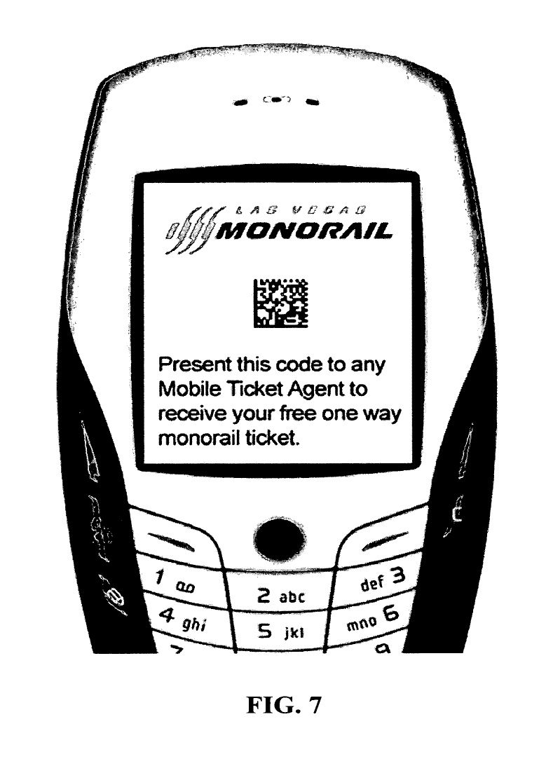

Referring to FIG. 7, another example of a mobile ticketing application comprises delivery of a digital ticket directly to device 20 (FIG. 1) and/or device 520 (FIG. 5). In this example, the ticket comes in the form of a two dimensional datamatrix, which is a type of barcode, as shown or, alternatively, in a traditional linear barcode delivered as a text message. The mobile handset is then scanned at the venue or point of use and is verified in real-time on a web-based or synchronized local database, e.g., using DSL, WIFI, LAN, 3G or GPRS wireless technologies.

In preferred embodiments, the ticket is acquired from messaging system 100 as described above. For example, the delivery of messages may be initiated on demand by the consumer through an IVR system (or DTMF hybrid system) where the consumer calls into messaging system 100 (FIG. 1)/500 (FIG. 5) and selects, inputs and requests that a SMS be sent to their phone—messaging system 100 automatically generates the message, automatically determines the mobile number and sends the message after the consumer has accepted the verbal terms and conditions to do so. Effectively, the response rate to such a campaign is one hundred percent since only those who authorize the sending of the text message and opt-in procedures are sent a SMS message.

In other embodiments, such mobile tickets, or information associated with such tickets, can be acquired from other access points including a box office, kiosk, web, IVR, call center, WAP or by text message. The tickets can be time and date specific, set for multiple entry and use, etc. The mobile ticketing application and system may be used in most sectors including transportation, leisure, events and entertainment, or anywhere else a paper ticket or coupon is required.

Messaging system 100 may utilize all available messaging methods such as SMS, EMS, NSMS, MMS and WAP for delivery. In addition, one or more of a suite of applications, e.g., JAVA, BREW, Symbian, Palm and Microsoft applications, may provide widespread coverage.

Other Embodiments and Features. Other exemplary applications that are found in various embodiments of the above-identified systems include, for example, gaming promotions, travel and hospitality programs, financial services, software and related services, real estate notifications, publishing promotions, education services and notifications and various other promotions and service notifications. In gaming applications, for example, messaging system 100 monitors and interacts with casino rewards programs and systems to provide the appropriate awards to the appropriate players. Examples of financial services include, for example, overdraft notices, fraud protection notices, account activity information, account balance information, and the like. Another application is advertising, where the system may be tied into a redemption system or used to capture personal information that is forwarded to the advertiser, particularly where the customer interfaces to the consumer are through the IVR system to get to the mobile device.

Preferably, messaging system 100 automatically detects the incoming number. If the number is blocked or the caller is calling from a wireline phone, the user may be prompted to enter their phone number. IVR system 128 preferably presents a menu with which the caller/consumer can interact in steps 322/336. IVR system 128 interacts with messaging system 134 to compose an appropriate unique message or predetermined message back to the caller/consumer. In some cases, the caller enters an ID number. Once the caller does this, messaging system 100 automatically associates the user's phone number with their ID number next time they call and the system dynamically looks up and composes the proper message to be sent to that caller/consumer and then routes the message through the callers/consumers carrier short message service center—or MSC.

Feature codes or keywords through SMS origination messages can also be used to initiate on demand participation messages as can browser WAP menus. However, a unique blending of the IVR and messages, in combination with message server information, leads to high customer response and redemption rates.

In some embodiments, message system 100 is configured to provide a wireless user 20 with personalized messages and requests for products and services via SMS or WAP in response to an offer or service that requires the caller/consumer to call or connect with a specific number and request the SMS service (e.g., from any telecommunications device). The SMS messages for this system can both be one-way mobile terminated messages which lower distribution costs, or in the PSMS model 2-way mobile messages where the consumer can connect back and interact with the service.

The blending of the IVR, SMS, database, content and monitoring system is unique. Other known or available marketing systems depend on people providing their information via a short code or data entry point like a web page, paper form, or other manual process. In some embodiments, messaging system 100 sits on top of existing carrier infrastructure as illustrated in FIGS. 1 and 5.

In some embodiments messaging system 100 can generate personalized dynamic real-time messages, and can process information to generate mass market as well as personalized messages for campaigns. A unique aspect is that the consumer calls for the message. This also provides a clear method to monitor the effectiveness of advertisement campaigns through redemption monitoring and call response to the campaign.

In some embodiments, messaging system 100 allows the consumer to request and approve the SMS message during the IVR call. This eliminates the OPT-IN and OPT-OUT problems as the consumer calls in to the IMMS system for a campaign message and approves for such message to be sent though IVR system 128, as opposed to a two-way SMS system. In some cases, two way and opt-in and out programs may require two way SMS communications, e.g., in business cases where ongoing programs for marketing occur. However it may be advantageous to send one way messages from a cost perspective.

The promotion and marketing offers may be presented and managed through IVR system 128 where the consumer can select the product and service they want sent to their phone though a menu system. The campaign provider can control the system message in real-time as well as the promotion through the system interface so the cost to manage continuous campaigns is controlled.

In some embodiments, the consumer can preview services and/or products through the IVR and understand fully what they are requesting. They can directly connect to customer service for more information at any time through the system as well as connect directly to a predetermined customer service number in the message. The system preferably interacts with outside databases and information sources in real-time where the message can be created and composed to dynamically create unique and specific messages for the consumer—an example of this is associating the caller with a customer loyalty program where their rewards or offers are determined by the campaign provider based upon business rules. This allows, for example, external information or data sources to provide real-time messaging on demand to the consumer.

Each message sent in step 354 can be serialized in real-time to monitor redemption on campaigns where consumers are being sent essentially the same message. This is different than just sending the same message to many consumers in bulk. In some embodiments, messaging system 100 automatically captures the consumer's phone number (e.g., in step 318 of FIG. 3), and can also verify that the number is a mobile number and looks up the correct carrier so that the message can be properly routed to the consumer's mobile phone via the carrier SMSC where, in most cases, the message can be tracked and logged.

In some cases, messaging costs may be paid to the carrier by the interactive mobile messaging system provider or the campaign originator. In other cases, messaging costs are born by the consumers. In alternative embodiments, a system provides a direct connect to a user to collect messages via a VPN connection between a consumer and supplier so that the consumer has access to instant information being offered or provided to them on a pull basis. In one example, a WAP initiated billing system generates SMS confirmation messages to the user.

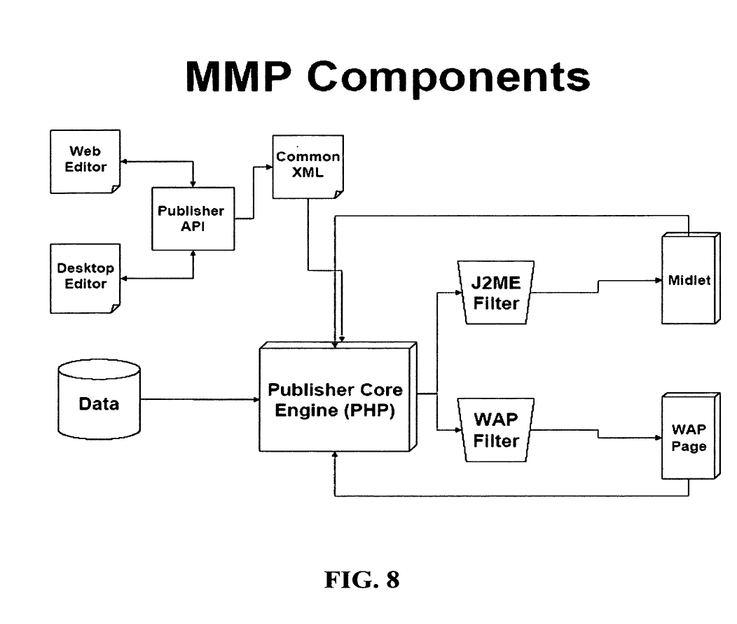

In another embodiment, a mobile publisher (MMP) system allows content creators to distribute content to J2ME and WAP enabled phones. By outputting content in a simple XML format, for example, information can be targeted for both rich J2ME clients and simple WAP interfaces with one backend platform. Such a backend may include, for example, a publisher API (page creation, database lookups), an XSLT Engine (to output content for both J2ME and WAP), and a JAR Package Manager (for dynamically creating J2ME JAR package). A front-end may include, for example, a WAP (xHTML) interface to PHP engine, and a J2ME application that views basic HTML documents. In one embodiment, a mobile publisher may include components as shown in FIG. 8.

The present invention can be implemented as a computer program product that comprises a computer program mechanism embedded in a computer readable storage medium. Further, any of the methods of the present invention can be implemented in one or more computers or computer systems. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer program product that contains any or all of the program modules shown in FIG. 1. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed is:

1. A method for sending a message to a user device, the method comprising:
(a) receiving a telephone call from a user device;
(b) automatically determining an identifier corresponding to the user device without user intervention;
(c) presenting a user with a menu of options using an interactive voice response system;
(d) receiving a selection or request for a text-based or graphic message from the user and approval to send the text-based or graphic message in response to the menu of options; and
(e) sending the text-based or graphic message to the user device using the identifier in response to the selection or request.

2. The method of claim 1, wherein the user device is a mobile phone and the identifier is the phone number of the mobile phone, the method further comprising:
determining the carrier for the user device based on the phone number of the mobile phone, wherein the sending the text-based or graphic message step (e) comprises sending the message to a SMS, PSMS, or MMS of the carrier for delivery to the user device.

3. The method of claim 1, wherein the client device is a mobile device.

4. The method of claim 1, wherein the client device is a cellular telephone.

5. The method of claim 1, wherein the identifier comprises the mobile identification number of the mobile device.

6. The method of claim 1, wherein the message comprises any of a coupon, an award, a prize or a promotion.

7. The method of claim 1, wherein the message is a gambling credit.

8. The method of claim 1, wherein the receiving a selection or request step (d) further comprises receiving an identification number corresponding to a customer loyalty program.

9. The method of claim 1, wherein the automatically determining step (b) comprises determining the mobile station identifier (MSID) associated with the user device, an E-mail address associated with the user device, a browser configuration of the user device, a user device model, a mobile equipment identifier (MEID) associated with the user device, the user device electronic serial number (ESN), or the user device operating system (OS).

10. The method of claim 1, wherein the automatically determining step (b) comprises collecting user location information and wherein the text-based or graphic message is a location-dependent offer, promotion or prize.

11. The method of claim 10, wherein the location information is determined from an area code of the user device, a location of the mobile station having the mobile station identifier MSID used by the user device, or a location based service (LBS).

12. The method of claim 1, the method further comprising:
(f) verifying an age of the user of the user device, wherein, when the age of the user is less than a threshold number of years, the text-based or graphic message is not sent to the user device.

13. The method of claim 1, wherein the sending step (e) comprises:
including a unique identifier in said text-based or graphic message that validated the authenticity of the message.

14. The method of claim 13, the method further comprising:
(f) communicating the unique identifier to a campaign distributor.

15. The method of claim 13, wherein the unique identifier is a serial number, a code number, or a one-dimensional bar code.

16. The method of claim 13, wherein the unique identifier is a two-dimensional bar code.

17. The method of claim 13, wherein the text-based or graphic message is a promotion, and wherein the method further comprises:
(f) tracking a redemption of a promotion or prize identified in the text-based or graphic message.

18. The method of claim 17, wherein the promotion or prize is redeemed at a redemption location and wherein the tracking step (f) communicating the redemption from the redemption location to a central server over a wide area network.

19. The method of claim 1, wherein the receiving a selection step (d) comprises receiving an account number or other code identifying a user as a member of a customer loyalty club and wherein the sending step (d) comprises: sending the text-based or graphic message when the account number or other code is a valid account number or other code; and
not sending the text-based or graphic message when the account number or other code is not a valid account number or other code.

20. The method of claim 19, wherein the loyalty club is a frequent flyer program, a frequent shopper club, a casino club programs, a hotel loyalty club, or a credit card points programs.

21. The method of claim 1, wherein the receiving a selection step (d) requesting an account number or other code identifying a user as a member of a customer loyalty club and wherein the sending step (d) comprises:
sending the text-based or graphic message when an account number or other code is received; and
assigning a temporary identification number and sending instructions on how to enroll in the customer loyalty program when the account number or other code is not received.

22. A computer system comprising a central processing unit and a memory coupled to the central processing unit, the memory comprising:
an interactive voice response system; and
instructions for:
(a) automatically determining an identifier corresponding to a user device without user intervention in response to a telephone call received from the user device;
(b) communicating a menu of options through the interactive voice response system to the user device;
(c) receiving a selection or request for a text-based or graphic message from the user and approval to send the text-based or graphic message in response to the menu of options; and
(d) sending the text-based or graphic message to the user device using the identifier in response to the selection or request.

23. The computer system of claim 22, wherein the user device is a mobile phone and the identifier is the phone number of the mobile phone, the memory further comprising instructions for:
determining the carrier for the user device based on the phone number of the mobile phone, wherein the sending the text-based or graphic message (e) comprises instructions for sending the message to a SMS, PSMS, or MMS of the carrier for delivery to the user device.

24. The computer system of claim 22, wherein the automatically determining (a) comprises collecting user location information and wherein the text-based or graphic message is a location-dependent offer, promotion or prize.

25. The computer system of claim 24, wherein the location information is determined from an area code of the user device, a location of the mobile station having the mobile station identifier MSID used by the user device, or a location based service (LBS).

26. The computer system of claim 22, wherein the sending (d) comprises:
including a unique identifier in said text-based or graphic message that validated the authenticity of the message.

27. The computer system of claim 26, wherein the unique identifier is a serial number, a code number, or a one-dimensional bar code.

28. The computer system of claim 26, wherein the unique identifier is a two-dimensional bar code.

29. A computer program product for use in conjunction with a computer system, the computer program product comprising a computer readable storage medium and a computer program mechanism embedded therein, the computer program mechanism comprising instructions for:
(a) automatically determining an identifier corresponding to a user device without user intervention in response to a telephone call received from the user device;
(b) communicating a menu of options through an interactive voice response system to the user device;
(c) receiving a selection or request for a text-based or graphic message from the user device and approval to send the text-based or graphic message in response to the menu of options; and
(d) sending the text-based or graphic message to the user device using the identifier in response to the selection or request.

30. The computer program product of claim 29, wherein the user device is a mobile phone and the identifier is the phone number of the mobile phone, the computer program mechanism further comprising instructions for:
determining the carrier for the user device based on the phone number of the mobile phone, wherein the sending the text-based or graphic message (e) comprises instructions for sending the message to a SMS, PSMS, or MMS of the carrier for delivery to the user device.
